(19) United States
(12) Patent Application Publication
(10) Pub. No.: US 2023/0206527 A1
(43) Pub. Date: Jun. 29, 2023

(54) SPECIAL-EFFECT EDITING METHOD AND APPARATUS

(71) Applicant: BEIJING ZITIAO NETWORK TECHNOLOGY CO., LTD., BEIJING (CN)

(72) Inventors: Gang YAN, Beijing (CN); Jing WANG, Beijing (CN); Yu LI, Beijing (CN)

(21) Appl. No.: 18/057,881

(22) Filed: Nov. 22, 2022

(30) Foreign Application Priority Data
Dec. 29, 2021 (CN) 202111637729.6

(51) Int. Cl. G06T 13/00; G06F 9/445; G06F 9/48

(52) U.S. Cl. CPC G06T 13/00; G06F 9/445; G06F 9/4881

(57) ABSTRACT

The present disclosure provide a special-effect editing method and apparatus, the method including: by an editor, receiving a first editing operation, generating a corresponding first editing instruction, and writing the first editing instruction into an instruction cache queue; by a resource manager, executing editing instructions in the instruction cache queue in sequence, and when executing the first editing instruction, editing a first object corresponding to the first editing instruction; by a graphic engine, loading objects corresponding to the editing instructions in the instruction cache queue in sequence, and when loading an object corresponding to the first editing instruction, sending request information for requesting loading a second object to the resource manager, the second object being an object obtained by editing the first object; sending the second object to the graphic engine in response to the request information by the resource manager; and rendering the second object by the graphic engine.

### CROSS-REFERENCE TO RELATED APPLICATIONS

The present application is based on and claims priority to Chinese Patent Application No. 202111637729.6 filed on Dec. 29, 2021, the disclosure of which is incorporated by reference herein in its entirety.

### TECHNICAL FIELD

This disclosure relates to the technical field of special-effect editing, and particularly to a special-effect editing method and apparatus.

### BACKGROUND

With the continuous development of science and technology, special effects are increasingly applied in scenes such as self-shooting, short video production, film production, live streaming, and the like, and since works after being processed by the special effects may exceed visual effects that can be achieved by actual shooting, the special effects provide powerful technical supports for improving quality of the works.

### SUMMARY

Embodiments of the present disclosure provide a special-effect editing method and apparatus. In a first aspect, an embodiment of the present disclosure provides a special-effect editing method, comprising:
an editor receiving a first editing operation, generating a first editing instruction corresponding to the first editing operation, and writing the first editing instruction into an instruction cache queue;
a resource manager executing editing instructions in the instruction cache queue in sequence, and when executing the first editing instruction, editing a first object corresponding to the first editing instruction according to the first editing instruction;
a graphic engine loading objects corresponding to the editing instructions in the instruction cache queue in sequence, and when loading an object corresponding to the first editing instruction, sending request information for requesting loading a second object to the resource manager, the second object being an object obtained by the resource manager by editing the first object according to the first editing instruction;
the resource manager sending the second object to the graphic engine in response to the request information; and
the graphic engine rendering the second object.

As an optional implementation of the embodiment of the present disclosure, the resource manager executing the editing instructions in the instruction cache queue in sequence comprises:

the resource manager executing the editing instructions in the instruction cache queue in sequence through a plurality of execution threads in parallel.

As an optional implementation of the embodiment of the present disclosure, the graphic engine loading the objects corresponding to the editing instructions in the instruction cache queue in sequence comprises: the graphic engine loading the objects corresponding to the editing instructions in the instruction cache queue in sequence through a plurality of loading threads in parallel.

As an optional implementation of the embodiment of the present disclosure, the method further comprises:
the resource manager generating a first feedback message corresponding to the first editing instruction, and writing the first feedback message into a first feedback message queue; and
the editor reading and outputting feedback messages in the first feedback message queue in sequence.

As an optional implementation of the embodiment of the present disclosure, the method further comprises:
the graphic engine generating a second feedback message corresponding to the first editing instruction, and writing the second feedback message into a second feedback message queue; and
the editor reading and outputting feedback messages in the second feedback message queue in sequence.

As an optional implementation of the embodiment of the present disclosure, the method further comprises: before the graphic engine renders the second object, the editor receiving a second editing operation, generating a second editing instruction corresponding to the second editing operation, and writing the second editing instruction into the instruction cache queue.

In a second aspect, an embodiment of the present disclosure provides a special-effect editing apparatus, comprising:
an editor configured to receive a first editing operation, generate a first editing instruction corresponding to the first editing operation, and write the first editing instruction into an instruction cache queue;
a resource manager configured to execute editing instructions in the instruction cache queue in sequence, and when executing the first editing instruction, edit a first object corresponding to the first editing instruction according to the first editing instruction;
a graphic engine configured to load objects corresponding to the editing instructions in the instruction cache queue in sequence, and when loading an object corresponding to the first editing instruction, send request information for requesting loading a second object to the resource manager, the second object being an object obtained by the resource manager by editing the first object according to the first editing instruction;
the resource manager further configured to send the second object to the graphic engine in response to the request information; and
the graphic engine further configured to render the second object.

As an optional implementation of the embodiment of the present disclosure, the resource manager is specifically configured to execute the editing instructions in the instruction cache queue in sequence through a plurality of execution threads in parallel.

As an optional implementation of the embodiment of the present disclosure, the graphic engine is specifically configured to load the objects corresponding to the editing instructions in the instruction cache queue in sequence through a plurality of loading threads in parallel.

As an optional implementation of the embodiment of the present disclosure, the resource manager is further configured to generate a first feedback message corresponding to the first editing instruction, and write the first feedback message into a first feedback message queue; and

the editor is further configured to read and output feedback messages in the first feedback message queue in sequence.

As an optional implementation of the embodiment of the present disclosure, the graphic engine is further configured to generate a second feedback message corresponding to the first editing instruction, and write the second feedback message into a second feedback message queue; and

the editor is further configured to read and output feedback messages in the second feedback message queue in sequence.

As an optional implementation of the embodiment of the present disclosure, the editor is further configured to, before the graphic engine renders the second object, receive a second editing operation, generate a second editing instruction corresponding to the second editing operation, and write the second editing instruction into the instruction cache queue.

In a third aspect, an embodiment of the present disclosure provides an electronic device, comprising: a memory and a processor, the memory being configured to store a computer program; the processor being configured to, when executing the computer program, causes the electronic device to implement the special-effect editing method according to any of the above implementations.

In a fourth aspect, an embodiment of the present disclosure provides a non-transitory computer-readable storage medium having thereon stored a computer program which, when executed by a computing device, causes the computing device to implement the special-effect editing method according to any of the above implementations.

In a fifth aspect, an embodiment of the present disclosure provides a computer program product which, when running on a computer, causes the computer to implement the special-effect editing method according to any of the above implementations.

### BRIEF DESCRIPTION OF THE DRAWINGS

The accompanying drawings herein, which are incorporated in and constitute a part of this description, illustrate embodiments consistent with the present disclosure and, together with the description, serve to explain the principles of the present disclosure.

In order to more clearly illustrate the embodiments of the present disclosure or technical solutions in the prior art, the drawings that need to be called in the description of the embodiments or the prior art will be briefly described below, and it is obvious that, for one of ordinary skill in the art, other drawings can also be obtained from these drawings without paying creative efforts.

FIG. 1 is an architecture diagram of a special-effect editing method according to an embodiment of the present disclosure;

FIG. 2 is a flow diagram of steps of a special-effect editing method according to an embodiment of the present disclosure;

FIG. 3 is a schematic diagram of a resource manager according to an embodiment of the present disclosure;

FIG. 4 is a schematic diagram of a graphic engine according to an embodiment of the present disclosure;

FIG. 5 is a schematic structural diagram of a special-effect editing apparatus according to an embodiment of the present disclosure; and

FIG. 6 is a schematic diagram of a hardware structure of an electronic device according to an embodiment of the present disclosure.

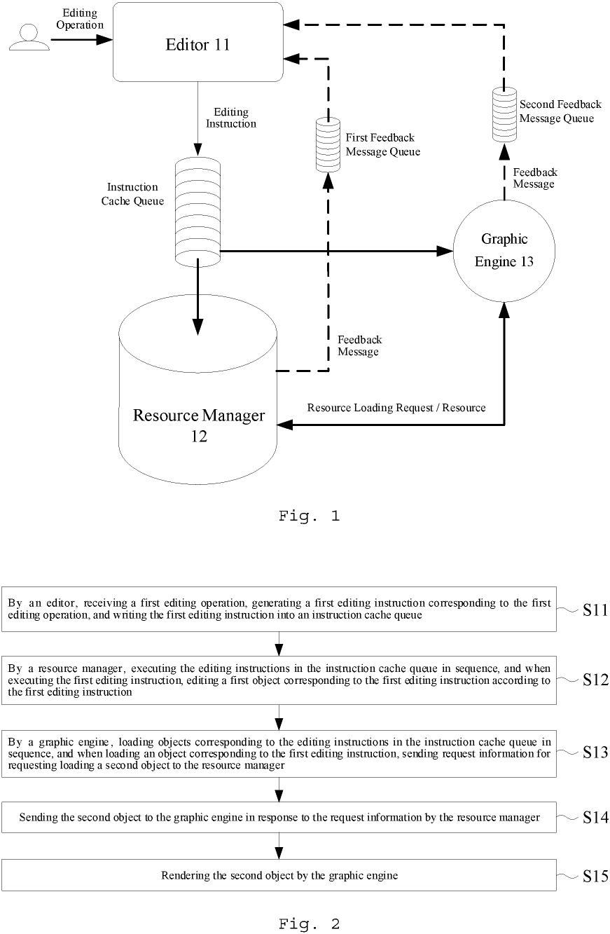

### DETAILED DESCRIPTION

In order to enable more clear understanding of the above objectives, features and advantages of the present disclosure, solutions of the present disclosure will be further described below. It should be noted that the embodiments of the present disclosure and features in the embodiments can be combined with each other provided there is no conflict.

In the following description, numerous specific details are set forth in order to facilitate full understanding of the present disclosure, but the present disclosure can also be implemented in other manners different from those described herein; and it is obvious that the embodiments in this specification are only part of the embodiments of the present disclosure, and not all of them.

In the embodiments of the present disclosure, words such as “exemplary” or “for example” are used for indicating giving an example, illustration or description. Any embodiment or design solution described as “exemplary” or “for example” in the embodiments of the present disclosure shall not be interpreted as more preferred or advantageous over other embodiments or design solutions. Rather, calling the word such as “exemplary” or “for example” is intended to present a related concept in a specific manner. Furthermore, in the description of the embodiments of the present disclosure, “a plurality” means two or more unless otherwise specified.

Generally, a special-effect editing system is composed of an editor, a graphic engine, and a resource manager. The editor provides special-effect editing and making capabilities, to facilitate a user making or editing special effects and hiding implementation details of the graphic engine; the graphic engine provides special-effect display and dynamic running capabilities, to facilitate the user checking whether the made or edited special effects meet an expected effect; and the digital resource manager is used for storing and managing related resources of the special effects, to facilitate the editor and the graphic engine loading the related resources. In the prior art, a process of performing special-effect editing through the special-effect editing system includes: the editor, when receiving an editing operation input by the user in the editor, editing a corresponding resource stored in the resource manager, the graphic engine loading and running the edited resource from the resource manager after the editing is completed to present the special-effect editing effect to the user, and the user being unable to input a next editing operation before the graphic engine loads and runs the edited resource from the resource manager. As described above, in the prior art, after the user inputs one editing operation, since the graphic engine needs to wait for the resource manager completing the editing of the corresponding resource before loading and running the edited resource, and the editor needs to wait for the graphic engine completing the loading and running of the edited resource before continuing receiving the next editing operation, the special-effect editing solution in the prior art is very easy to block the user’s editing operation due to resource operation or resource loading.

In view of this, embodiments of the present disclosure provide a special-effect editing method and apparatus, for avoiding an editing operation of a user from being blocked, and improving fluency of special-effect editing.

According to the special-effect editing method provided by the embodiment of the present disclosure, an editor, when receiving a first editing operation, generates a first editing instruction corresponding to the first editing operation, and writes the first editing instruction into an instruction cache queue, a resource manager reads editing instructions in the instruction cache queue in sequence, and when executing the first editing instruction, edits the first object corresponding to the first editing instruction according to the first editing instruction, a graphic engine loads objects corresponding to the editing instructions in the instruction cache queue in sequence, and when loading an object corresponding to the first editing instruction, sends the request information for requesting loading the first object edited by the resource manager to the resource manager, the resource manager sends the edited first object to the graphic engine, and finally the graphic engine renders the edited first object. Since the editor, the resource manager, and the graphic engine in the special-effect editing method provided by the embodiment of the present disclosure interact through the instruction cache queue, the special-effect editing method provided by the embodiment of the present disclosure decouples the editor, the resource manager, and the graphic engine, and avoids mutual waiting among the editor, the resource manager, and the graphic engine, so that the embodiment of the present disclosure can avoid the editing operation of the user from being blocked, and improve the fluency of the special-effect editing.

A scene architecture diagram of a special-effect editing method provided in an embodiment of the present disclosure will be firstly described below.

As shown in FIG. 1, a scene architecture of a special-effect editing method provided in an embodiment of the present disclosure comprises: an editor 11, a resource manager 12, and a graphic engine 13.

The editor 11 is configured to receive an editing operation input by a user, generate an editing instruction for editing a corresponding resource stored in the resource manager 12 according to the received editing operation, and write the editing instruction into an instruction cache queue. The resource manager 12 is configured to read the editing instructions in the instruction cache queue in sequence, edit the corresponding resource according to the read editing instruction, and in response to a resource loading request of the editor 11 or the graphic engine 13, send a responded resource to the editor 11 or the graphic engine 13. The graphic engine 13 is configured to read the editing instructions in the instruction cache queue in sequence, and when reading a certain editing instruction, send, to the resource manager 12, request information for requesting loading a resource obtained by editing the responded resource according to the editing instruction, and after loading the resource, render, run, and display the resource. In addition, the resource manager 12 is further configured to generate a feedback message according to an execution result of the read editing instruction, and write the feedback message into a first feedback message queue, and the editor 11 is further configured to output feedback messages in the first feedback message queue in sequence, to facilitate the user checking a running state of the resource manager 12. The graphic engine 13 is further configured to generate a feedback message according to a resource loading result, a resource running result, a resource rendering result, and the like, and write the feedback message into a second feedback message queue, and the editor 11 is further configured to output feedback messages in the second feedback message queue in sequence, to facilitate the user checking a running state of the graphic engine 13.

It should be noted that, the editor 11, the resource manager 12, and the graphic engine 13 in the embodiment of the present disclosure can be different function modules in one same hardware device, or can be hardware devices independent of each other, which is not limited in this embodiment of the present disclosure and is subject to that the editor 11, the resource manager 12, and the graphic engine 13 can all implement corresponding functions.

An embodiment of the present disclosure provides a special-effect editing method, and as shown in FIG. 1, the special-effect editing method comprises the following steps S11 to S15.

S11, the editor receiving a first editing operation, generating a first editing instruction corresponding to the first editing operation, and writing the first editing instruction into an instruction cache queue.

Exemplarily, the first editing operation in the embodiment of the present disclosure can specifically include: an operation for creating an object, an operation for deleting an object, an operation for modifying an attribute value of an object, and the like, and the editing operation is not limited in the embodiment of the present disclosure, and can include any one or more editing operations on one or more objects in an editing scene.

The editing instruction in the embodiment of the present disclosure refers to: an instruction for instructing the resource manager to perform a corresponding operation on a resource operated by the editing operation. For another example: if the first editing operation is an operation for modifying an attribute value of an object A from ×0 to ×1, a first editing instruction generated by an editor can include: an identification of the object A and an operation content “modifying ×0 to ×1”. The identification of the object can be a universally unique identifier (UUID) of the object.

In the embodiment of the present disclosure, the editor, when writing the editing instruction into the instruction cache queue, always writes the editing instruction into a tail of the instruction cache queue. That is, the editing instructions in the cache queue are ranked in the writing sequence.

S12, the resource manager executing the editing instructions in the instruction cache queue in sequence, and when executing the first editing instruction, editing a first object corresponding to the first editing instruction according to the first editing instruction.

Specifically, the resource manager executing the editing instructions in the instruction cache queue in sequence refers to: the resource manager executing the editing instructions in the instruction cache queue in sequence from the first to the last in the ranking sequence of the editing instructions in the cache queue.

As an optional implementation of the embodiment of the present disclosure, an implementation of the above step S12 (namely, the resource manager executing the editing instructions in the instruction cache queue in sequence) comprises: the resource manager executing the editing instructions in the instruction cache queue in sequence through a plurality of execution threads in parallel.

Since the special-effect editing method provided by the above embodiment executes the editing instructions in the instruction cache queue in sequence through the plurality of execution threads in parallel, the execution of other editing instructions in the instruction cache queue will not be blocked due to the blocked execution of a certain editing instruction in the embodiment of the present disclosure.

Exemplarily, referring to FIG. 3, in FIG. 3, taking an example that the resource manager executes the editing instructions in the instruction cache queue through three execution threads, A, B, and C in parallel, the implementation of the resource manager executing the editing instructions in the instruction cache queue in sequence through the plurality of execution threads in parallel is described. As shown in FIG. 3, the instruction cache queue includes in sequence from the head to the tail: editing instructions 1, 2, 3, 4, ..., and n, and the resource manager firstly executes the editing instruction 1 through the execution thread A, executes the editing instruction 2 through the execution thread B and executes the editing instruction 3 through the execution thread C; after a period of time, the execution thread A completes the execution of the editing instruction 1 first, and the resource manager executes the editing instruction 4 in the instruction cache queue through the execution thread A, so that at this time, the execution thread A executes the editing instruction 4, the execution thread B executes the editing instruction 2, and the execution thread C executes the editing instruction 3; after another period of time, the execution thread C completes the execution of the editing instruction 3, and the resource manager executes the editing instruction 5 in the instruction cache queue through the execution thread C, so that at this time, the execution thread A executes the editing instruction 4, the execution thread B executes the editing instruction 2, and the execution thread C executes the editing instruction 5; and after a further period of time, the execution thread A completes the execution of the editing instruction 4, and the resource manager executes the editing instruction 6 in the instruction cache queue through the execution thread A, so that at this time, the execution thread A executes the editing instruction 6, the execution thread B executes the editing instruction 2, and the execution thread C executes the editing instruction 5, until the execution of all the editing instructions in the instruction cache queue are completed. Although the execution of the editing instruction 2 is blocked (takes a long time or cannot be executed) , the execution of other editing instructions in the instruction cache queue is not be blocked.

Optionally, after the execution thread starts to execute an editing instruction in the instruction cache queue, the editing instruction that start to be executed can be deleted from the instruction cache queue, so that the execution thread is configured to always execute the first editing instruction in the instruction cache queue when executing the editing instructions in the instruction cache queue.

S13, the graphic engine loading objects corresponding to the editing instructions in the instruction cache queue in sequence, and when loading an object corresponding to the first editing instruction, sending request information for requesting loading a second object to the resource manager.

The second object is an object obtained by the resource manager by editing the first object according to the first editing instruction.

Specifically, the graphic engine executing the editing instructions in the instruction cache queue in sequence refers to: the graphic engine loading the objects corresponding to the editing instructions in the instruction cache queue in sequence from the first to the last in the ranking sequence of the editing instructions in the cache queue.

As an optional implementation of the embodiment of the present disclosure, an implementation of the above step S13 (namely, the graphic engine loading the objects corresponding to the editing instructions in the instruction cache queue in sequence) comprises:

the graphic engine loading the objects corresponding to the editing instructions in the instruction cache queue in sequence through a plurality of loading threads in parallel.

Since the special-effect editing method provided by the above embodiment loads the objects corresponding to the editing instructions in the instruction cache queue in sequence through the plurality of loading threads in parallel, the loading of objects corresponding to other editing instructions in the instruction cache queue will not be blocked due to the blocked loading of an object corresponding to a certain editing instruction in the embodiment of the present disclosure.

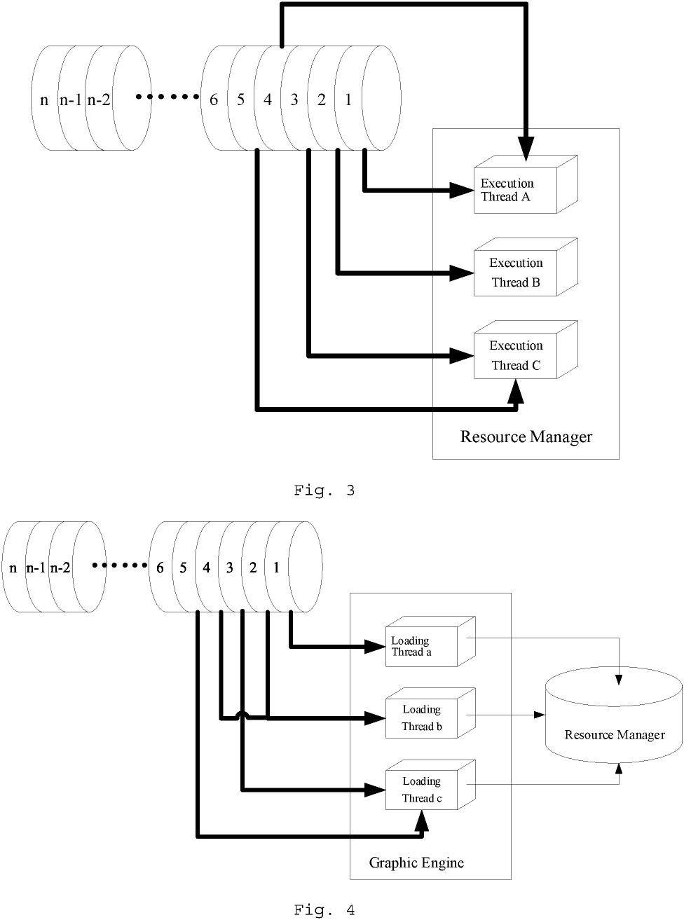

Exemplarily, referring to FIG. 4, in FIG. 4, taking an example that the graphic engine loads the objects corresponding to the editing instructions in the instruction cache queue through three loading threads, a, b, and c in parallel, the implementation of the graphic engine loading the objects corresponding to the editing instructions in the instruction cache queue in sequence through the plurality of loading threads in parallel is described. As shown in FIG. 4, the instruction cache queue includes in sequence from the head to the tail: editing instructions 1, 2, 3, 4, ..., and n, and the graphic engine firstly loads an object corresponding to the editing instruction 1 through the loading thread a, loads an object corresponding to the editing instruction 2 through the loading thread b, and loads an object corresponding to the editing instruction 3 through the loading thread c; after a period of time, the loading thread b completes the loading of the object corresponding to the editing instruction 2 first, and the graphic engine loads an object corresponding to the editing instruction 4 in the instruction cache queue through the loading thread b, so that at this time, the loading thread a loads the object corresponding to the editing instruction 1, the loading thread b loads the object corresponding to the editing instruction 4, and the loading thread c loads the object corresponding to the editing instruction 3; and after another period of time, the loading thread c completes the loading of the object corresponding to the editing instruction 3 first, and the graphic engine loads an object corresponding to the editing instruction 5 in the instruction cache queue through the loading thread c, so that at this time, the loading thread a loads the object corresponding to the editing instruction 1, the loading thread b loads the object corresponding to the editing instruction 4, and the loading thread c loads the object corresponding to the editing instruction 5, until the loading of all the objects corresponding to the editing instructions in the instruction cache queue are completed. Although the loading of the object corresponding to the editing instruction 1 is blocked (takes a longer time or cannot be loaded), the loading of objects corresponding to other editing instructions in the instruction cache queue is not blocked.

S14, the resource manager sending the second object to the graphic engine in response to the request information.

Optionally, the resource manager, when receiving the request information for requesting the second object that is sent by the graphic engine, first judges whether the execution of the first editing instruction is completed; if the execution of the first editing instruction is completed, sends the second object to the graphic engine; and if the execution of the first editing instruction is not completed, waits for the completion of the execution of the first editing instruction, and sends the second object to the graphic engine after the execution of the first editing instruction is completed.

S15, the graphic engine rendering the second object.

Since the graphic engine renders the second object, the user can check whether the editing effect of the first editing operation is consistent with an expected effect through the second object displayed by the graphic engine.

According to the special-effect editing method provided by the embodiment of the present disclosure, the editor, when receiving the first editing operation, generates the first editing instruction corresponding to the first editing operation, and writes the first editing instruction into the instruction cache queue, the resource manager reads the editing instructions in the instruction cache queue in sequence, and when executing the first editing instruction, edits the first object corresponding to the first editing instruction according to the first editing instruction, the graphic engine loads the objects corresponding to the editing instructions in the instruction cache queue in sequence, and when loading the object corresponding to the first editing instruction, sends the request information for requesting loading the first object edited by the resource manager to the resource manager, the resource manager sends the edited first object to the graphic engine, and finally the graphic engine renders the edited first object. Since the editor, the resource manager, and the graphic engine in the special-effect editing method provided by the embodiment of the present disclosure interact through the instruction cache queue, the special-effect editing method provided by the embodiment of the present disclosure decouples the editor, the resource manager, and the graphic engine, and avoids mutual waiting among the editor, the resource manager, and the graphic engine, so that the embodiment of the present disclosure can avoid the editing operation of the user from being blocked, and improve the fluency of the special-effect editing.

As an optional implementation of the embodiment of the present disclosure, the special-effect editing method provided by the embodiment of the present disclosure further comprises:
the resource manager generating a first feedback message corresponding to the first editing instruction, and writing the first feedback message into a first feedback message queue; and
the editor reading and outputting feedback messages in the first feedback message queue in sequence.

Since the first feedback message corresponding to the first editing instruction that is generated by the resource manager is not directly sent to the editor, the execution result of the editing instruction that is fed back by the resource manager will not block the running of the editor, thereby further avoiding blocking the user’s input of the editing operation on the editor.

As an optional implementation of the embodiment of the present disclosure, the special-effect editing method provided by the embodiment of the present disclosure further comprises:
the graphic engine generating a second feedback message corresponding to the first editing instruction, and writing the second feedback message into a second feedback message queue;and
the editor reading and outputting feedback messages in the second feedback message queue in sequence.

Since the second feedback message corresponding to the first editing instruction that is generated by the graphic engine is not directly sent to the editor, the running result of the object corresponding to the editing instruction that is fed back by the graphic engine will not block the running of the editor, thereby further avoiding blocking the user’s input of the editing operation on the editor.

As an optional implementation of the embodiment of the present disclosure, the special-effect editing method provided by the embodiment of the present disclosure further comprises:

before the graphic engine renders the second object, the editor receiving a second editing operation, generating a second editing instruction corresponding to the second editing operation, and writing the second editing instruction into the instruction cache queue.

That is, the editor can continuously receive the editing operations, without waiting for the completion of the execution of a previous editing operation before receiving a next editing operation, so that the above embodiment can further avoid blocking the user’s input of the editing operation on the editor.

Based on the same invention concept, as an implementation of the above method, an embodiment of the present disclosure further provides a special-effect editing apparatus, and this embodiment corresponds to the above method embodiment, and for convenience of reading, details in the above method embodiment are not repeated in this embodiment one by one, but it should be appreciated that the special-effect editing apparatus in this embodiment can correspondingly implement all the contents in the above method embodiment.

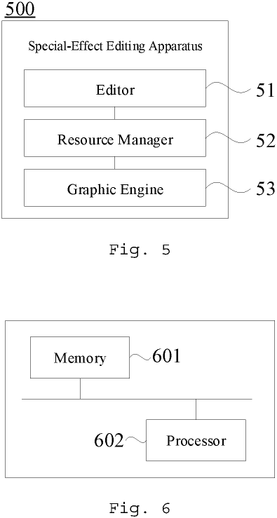

An embodiment of the present disclosure provides a special-effect editing apparatus, and FIG. 5 is a schematic structural diagram of the special-effect editing apparatus, as shown in FIG. 5, the special-effect editing apparatus 500 comprising:
an editor 51 configured to receive a first editing operation, generate a first editing instruction corresponding to the first editing operation, and write the first editing instruction into an instruction cache queue;
a resource manager 52 configured to execute editing instructions in the instruction cache queue in sequence, and when executing the first editing instruction, edit a first object corresponding to the first editing instruction according to the first editing instruction;
a graphic engine 53 configured to load objects corresponding to the editing instructions in the instruction cache queue in sequence, and when loading an object corresponding to the first editing instruction, send request information for requesting loading a second object to the resource manager, the second object being an object obtained by the resource manager by editing the first object according to the first editing instruction;
the resource manager 52 further configured to send the second object to the graphic engine in response to the request information; and
the graphic engine 53 further configured to render the second object.

As an optional implementation of the embodiment of the present disclosure, the resource manager 52 is specifically configured to execute the editing instructions in the instruction cache queue in sequence through a plurality of execution threads in parallel.

As an optional implementation of the embodiment of the present disclosure, the graphic engine 53 is specifically configured to load objects corresponding to the editing instructions in the instruction cache queue in sequence through a plurality of loading threads in parallel.

As an optional implementation of the embodiment of the present disclosure, the resource manager 52 is further configured to generate a first feedback message corresponding to the first editing instruction, and write the first feedback message into a first feedback message queue; and

the editor 51 is further configured to read and output feedback messages in the first feedback message queue in sequence.

As an optional implementation of the embodiment of the present disclosure, the graphic engine 53 is further configured to generate a second feedback message corresponding to the first editing instruction, and write the second feedback message into a second feedback message queue; and

the editor 51 is further configured to read and output feedback messages in the second feedback message queue in sequence.

As an optional implementation of the embodiment of the present disclosure, the editor 51 is further configured to, before the graphic engine renders the second object, receive a second editing operation, generate a second editing instruction corresponding to the second editing operation, and write the second editing instruction into the instruction cache queue.

The special-effect editing apparatus provided in this embodiment can execute the special-effect editing method provided in the above method embodiment, and they are similar in implementation principles and technical effects, which are not repeated herein.

Based on the same invention concept, an embodiment of the present disclosure further provides an electronic device. FIG. 6 is a schematic structural diagram of an electronic device provided by an embodiment of the present disclosure, as shown in FIG. 6, the electronic device provided by the embodiment comprising: a memory 601 and a processor 602, the memory 601 being configured to store a computer program; and the processor 602 being configured to perform, when executing the computer program, the special-effect editing method provided by the above embodiments.

Based on the same invention concept, an embodiment of the present disclosure further provides a non-transitory computer-readable storage medium having thereon stored a computer program which, when executed by a computing device, causes the computing device to implement the special-effect editing method provided by the above embodiments.

Based on the same invention concept, an embodiment of the present disclosure further provides a computer program product which, when running on a computer, causes the computer to implement the special-effect editing method provided by the above embodiments.

It should be appreciated by one skilled in the art that, the embodiments of the present disclosure can be provided as a method, system, or computer program product. Accordingly, the present disclosure can take a form of an entire hardware embodiment, an entire software embodiment or an embodiment combining software and hardware aspects. Moreover, the present disclosure can take a form of a computer program product implemented on one or more computer-usable storage media having computer-usable program code embodied therein.

The processor can be a central processing unit (CPU), and can also be another general-purpose processor, a digital signal processor (DSP), an application specific integrated circuit (ASIC), a field-programmable gate array (FPGA) or other programmable logic devices, a discrete gate or transistor logic, a discrete hardware component, etc. The general-purpose processor can be a microprocessor and can also be any conventional processor, or the like.

The memory can include a non-permanent memory, random access memory (RAM), and/or non-volatile memory in a computer-readable medium, such as a read-only memory (ROM) or flash memory (flash RAM) . The memory is an example of the computer-readable medium.

The computer-readable medium includes permanent and non-permanent, removable and non-removable storage media. The storage medium can implement information storage by any method or technology, and information can be a computer-readable instruction, data structure, a module of a program, or other data. Examples of the storage medium of a computer include, but are not limited to, a phase-change random access memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disks (DVD) or other optical storage, magnetic cassette, magnetic disk storage or other magnetic storage device, or any other non-transmission medium, which can be used for storing information that can be accessed by the computing device. As defined herein, the computer-readable medium does not include computer readable transitory media such as modulated data signals and carrier waves.

Finally, it should be noted that: the above embodiments are only used for illustrating the technical solutions of the present disclosure, and not limiting them; while the present disclosure has been described in detail with reference to the foregoing embodiments, it should be understood by one of ordinary skill in the art that: the technical solutions described in the foregoing embodiments can be modified, or some or all of the technical features can be equivalently replaced; and these modifications or replacements do not make the spirit of corresponding technical solutions depart from the scope of the technical solutions of the embodiments of the present disclosure.

What is claimed is:

1. A special-effect editing method, comprising:
by an editor, receiving a first editing operation, generating a first editing instruction corresponding to the first editing operation, and writing the first editing instruction into an instruction cache queue;
by a resource manager, executing editing instructions in the instruction cache queue in sequence, and when executing the first editing instruction, editing a first object corresponding to the first editing instruction according to the first editing instruction;
by a graphic engine, loading objects corresponding to the editing instructions in the instruction cache queue in sequence, and when loading an object corresponding to the first editing instruction, sending request information for requesting loading a second object to the resource manager, the second object being an object obtained by the resource manager by editing the first object according to the first editing instruction;
sending the second object to the graphic engine in response to the request information by the resource manager; and
rendering the second object by the graphic engine.

2. The method according to claim 1, wherein the executing the editing instructions in the instruction cache queue in sequence by the resource manager comprises:
executing the editing instructions in the instruction cache queue in sequence through a plurality of execution threads in parallel by the resource manager.

3. The method according to claim 1, wherein the loading the objects corresponding to the editing instructions in the instruction cache queue in sequence by the graphic engine comprises:
loading the objects corresponding to the editing instructions in the instruction cache queue in sequence through a plurality of loading threads in parallel by the graphic engine.

4. The method according to claim 1, wherein the method further comprises:
by the resource manager, generating a first feedback message corresponding to the first editing instruction, and writing the first feedback message into a first feedback message queue; and
by the editor, reading and outputting feedback messages in the first feedback message queue in sequence.

5. The method according to claim 1, wherein the method further comprises:
by the graphic engine, generating a second feedback message corresponding to the first editing instruction, and writing the second feedback message into a second feedback message queue; and
by the editor, reading and outputting feedback messages in the second feedback message queue in sequence.

6. The method according to claim 1, wherein the method further comprises:
before the graphic engine renders the second object, by the editor, receiving a second editing operation, generating a second editing instruction corresponding to the second editing operation, and writing the second editing instruction into the instruction cache queue.

7. A special-effect editing apparatus, comprising:
an editor configured to receive a first editing operation, generate a first editing instruction corresponding to the first editing operation, and write the first editing instruction into an instruction cache queue;
a resource manager configured to execute editing instructions in the instruction cache queue in sequence, and when executing the first editing instruction, edit a first object corresponding to the first editing instruction according to the first editing instruction;
a graphic engine configured to load objects corresponding to the editing instructions in the instruction cache queue in sequence, and when loading an object corresponding to the first editing instruction, send request information for requesting loading a second object to the resource manager, the second object being an object obtained by the resource manager by editing the first object according to the first editing instruction;
the resource manager further configured to send the second object to the graphic engine in response to the request information; and
the graphic engine further configured to render the second object.

8. The apparatus according to claim 7, wherein the resource manager is further configured to execute the editing instructions in the instruction cache queue in sequence through a plurality of execution threads in parallel.

9. The apparatus according to claim 7, wherein the graphic engine is further configured to load the objects corresponding to the editing instructions in the instruction cache queue in sequence through a plurality of loading threads in parallel.

10. The apparatus according to claim 7, wherein the resource manager is further configured to generate a first feedback message corresponding to the first editing instruction, and write the first feedback message into a first feedback message queue; and
the editor is further configured to read and output feedback messages in the first feedback message queue in sequence.

11. The apparatus according to claim 7, wherein the graphic engine is further configured to generate a second feedback message corresponding to the first editing instruction, and write the second feedback message into a second feedback message queue; and
the editor is further configured to read and output feedback messages in the second feedback message queue in sequence.

12. The apparatus according to claim 7, wherein before the graphic engine renders the second object, the editor is further configured to receive a second editing operation, generate a second editing instruction corresponding to the second editing operation, and write the second editing instruction into the instruction cache queue.

13. An electronic device, comprising: a memory and a processor, the memory being configured to store a computer program; the processor being configured to, when executing the computer program, causes the electronic device to implement the special-effect editing method according to claim 1.

14. A non-transitory computer-readable storage medium, wherein the computer-readable storage medium has thereon stored a computer program which, when executed by a computing device, causes the computing device to perform the step of
by an editor, receiving a first editing operation, generating a first editing instruction corresponding to the first editing operation, and writing the first editing instruction into an instruction cache queue;
by a resource manager, executing editing instructions in the instruction cache queue in sequence, and when executing the first editing instruction, editing a first object corresponding to the first editing instruction according to the first editing instruction;
by a graphic engine, loading objects corresponding to the editing instructions in the instruction cache queue in sequence, and when loading an object corresponding to the first editing instruction, sending request information for requesting loading a second object to the resource manager, the second object being an object obtained by the resource manager by editing the first object according to the first editing instruction;
sending the second object to the graphic engine in response to the request information by the resource manager; and
rendering the second object by the graphic engine.

15. The non-transitory computer-readable storage medium according to claim 14, wherein the executing the editing instructions in the instruction cache queue in sequence by the resource manager comprises:
executing the editing instructions in the instruction cache queue in sequence through a plurality of execution threads in parallel by the resource manager.

16. The non-transitory computer-readable storage medium according to claim 14, wherein the loading the objects corresponding to the editing instructions in the instruction cache queue in sequence by the graphic engine comprises:
loading the objects corresponding to the editing instructions in the instruction cache queue in sequence through a plurality of loading threads in parallel by the graphic engine.

17. The non-transitory computer-readable storage medium according to claim 14, wherein when the computer program executed by the computing device, further causes the computing device to perform the step of:
by the resource manager, generating a first feedback message corresponding to the first editing instruction, and writing the first feedback message into a first feedback message queue; and
by the editor, reading and outputting feedback messages in the first feedback message queue in sequence.

18. The non-transitory computer-readable storage medium according to claim 14, wherein when the computer program executed by the computing device, further causes the computing device to perform the step of:
by the graphic engine, generating a second feedback message corresponding to the first editing instruction, and writing the second feedback message into a second feedback message queue; and
by the editor, reading and outputting feedback messages in the second feedback message queue in sequence.

19. The non-transitory computer-readable storage medium according to claim 14, wherein when the computer program executed by the computing device, further causes the computing device to perform the step of:
before the graphic engine renders the second object, by the editor, receiving a second editing operation, generating a second editing instruction corresponding to the second editing operation, and writing the second editing instruction into the instruction cache queue.

20. A computer program product, wherein the computer program product, when running on a computer, causes the computer to implement the special-effect editing method according to claim 1.
